(19) United States
(12) Patent Application Publication
(10) Pub. No.: US 2020/0166963 A1
(43) Pub. Date: May 28, 2020

(54) DISPLAY DEVICE WITH TWO-PIECE REAR COVER

(71) Applicant: QISDA CORPORATION, Taoyuan City (TW)

(72) Inventors: Chun-Jung Tsuo, Taoyuan City (TW); Shih-An Lin, New Taipei City (TW); Yi-Cheng Kuo, Taoyuan City (TW)

(21) Appl. No.: 16/299,145

(22) Filed: Mar. 12, 2019

(30) Foreign Application Priority Data
Nov. 28, 2018 (CN) 201811469522.0

(51) Int. Cl. G06F 1/16; G02F 1/1333

(52) U.S. Cl. CPC G06F 1/1601; G02F 1/133308; G02F 2001/133325; G02F 2001/13332; G02F 2001/133314

(57) ABSTRACT

A display device includes a panel module, a first rear cover and a second rear cover. The first rear cover is connected to the panel module. The second rear cover is connected to the first rear cover. Since the first rear cover is connected to the panel module, a front bezel of the panel module can be used as an appearance component, so as to form a narrow and thin frame for the display device. The second rear cover can be disassembled from the first rear cover, so as to maintain inner components of the display device.

### BACKGROUND OF THE INVENTION

### 1. Field of the Invention

The invention relates to a display device and, more particularly, to a display device equipped with a two-piece rear cover.

### 2. Description of the Prior Art

To satisfy a user with the requirements of image quality and appearance, there is a tendency towards a narrow frame for designing a display device. To form a narrow and thin frame for the display device, some prior arts use a front bezel of a panel module as an appearance component and fix a one-piece rear cover to a back plate of the panel module. Since the one-piece rear cover cannot be assembled to or disassembled from the back plate of the panel module arbitrarily, the maintenance of the display device is inconvenient.

### SUMMARY OF THE INVENTION

An objective of the invention is to provide a display device equipped with a two-piece rear cover, so as to solve the aforesaid problems.

According to an embodiment of the invention, the display device comprises a panel module, a first rear cover and a second rear cover. The first rear cover is connected to the panel module. The second rear cover is connected to the first rear cover.

As mentioned in the above, the invention uses the first rear cover and the second rear cover to form a two-piece rear cover. An operator only needs to connect the first rear cover to the panel module first and then connect the second rear cover to the first rear cover, such that the assembly of the display device is completed. Furthermore, the operator only needs to disassemble the second rear cover from the first rear cover, so as to maintain inner components of the display device. Since the first rear cover is connected to the panel module, a front bezel of the panel module can be used as an appearance component, so as to form a narrow and thin frame for the display device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a rear view illustrating a display device according to an embodiment of the invention.

FIG. 2 is a sectional view illustrating the display device along line X-X shown in FIG. 1.

FIG. 3 is a partial sectional view illustrating a display device according to another embodiment of the invention.

### DETAILED DESCRIPTION

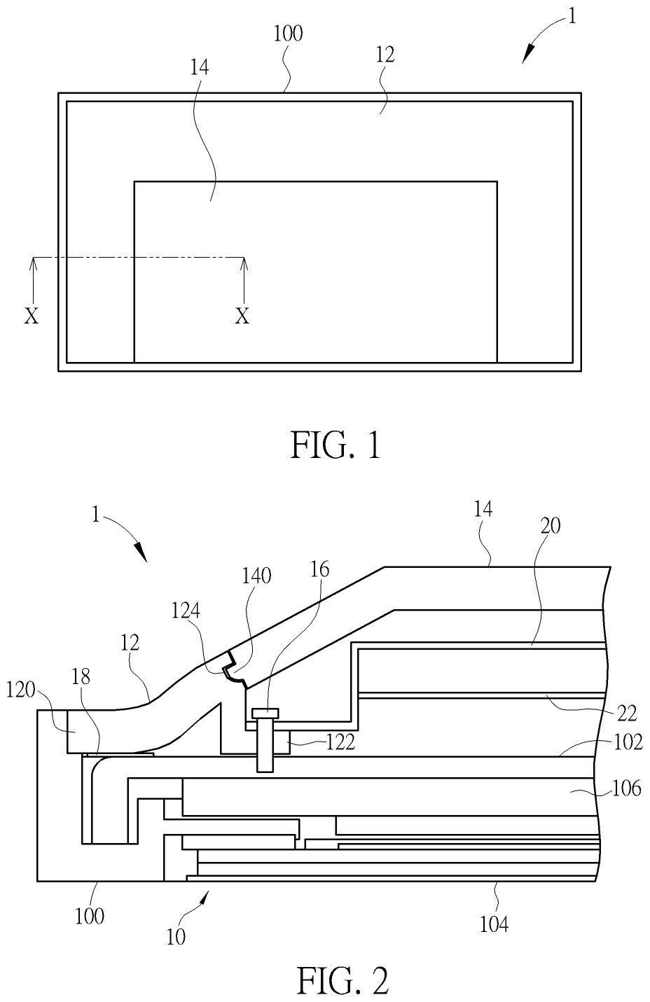

Referring to FIGS. 1 and 2, FIG. 1 is a rear view illustrating a display device 1 according to an embodiment of the invention and FIG. 2 is a sectional view illustrating the display device 1 along line X-X shown in FIG. 1.

As shown in FIGS. 1 and 2, the display device 1 comprises a panel module 10, a first rear cover 12 and a second rear cover 14. In this embodiment, the panel module 10 may comprise a front bezel 100, a back plate 102, a display panel 104 (e.g. liquid crystal display panel) and a backlight module 16. The front bezel 100 may be connected to the back plate 102 by engaging structures. The display panel 104 is fixed on the front bezel 100. The backlight module 106 is disposed between the display panel 104 and the back plate 102 and used to provide light for the display panel 104.

To assemble the display device 1, an operator may connect the first rear cover 12 to the panel module 10 first. In this embodiment, the first rear cover 12 may comprise a first fixing portion 120 and a second fixing portion 122. Furthermore, the display device 1 may further comprise a screw 16. As shown in FIG. 2, the first fixing portion 120 may be adhered to the back plate 102 by an adhesive 18 and the screw 16 may fix the second fixing portion 122 to the back plate 102, such that the first rear cover 12 is connected to the back plate 102 of the panel module 10. In this embodiment, the first rear cover 12 may be U-shaped. In another embodiment, the first rear cover 12 may also be O-shaped according to practical applications. At this time, the first fixing portion 120 may be located at an outer edge of the first rear cover 12 and the second fixing portion 122 may be located at an inner edge of the first rear cover 12. In this embodiment, the invention may dispose a plurality of second fixing portions 122 at the inner edge of the first rear cover 12 and use a plurality of screws 16 to fix the second fixing portions 122 to the back plate 102, respectively. Accordingly, the first rear cover 12 can be connected to the panel module 10 stably.

It should be noted that the first fixing portion 120 may also be fixed to the back plate 102 by a screw and the second fixing portion 122 may also be adhered to the back plate 102 by an adhesive according to practical applications.

In this embodiment, the display device 1 may further comprise a metal plate 20 and a circuit board 22, wherein the circuit board 22 is fixed to the metal plate 20. The metal plate 20 is used to provide electromagnetic interference (EMI) shielding function for the circuit board 22 and other electronic components. When using the screw 16 to fix the second fixing portion 122 to the back plate 102, the screw 16 can fix the metal plate 20 to the second fixing portion 122 simultaneously. In other words, the invention may use the screw 16 to fix the metal plate 20 and the first rear cover 12 together to the back plate 102 of the panel module 10.

After connecting the first rear cover 12 to the panel module 10, the operator further connects the second rear cover 14 to the first rear cover 12. In this embodiment, the first rear cover 12 comprises a first engaging portion 124 and the second rear cover 14 comprises a second engaging portion 140. As shown in FIG. 2, the second engaging portion 140 engages with the first engaging portion 124, such that the second rear cover 14 is connected to the first rear cover 12. In this embodiment, the invention may dispose a plurality of first engaging portions 124 at an inner edge of the first rear cover 12 and dispose a plurality of second engaging portions 140 at an outer edge of the second rear cover 14. Accordingly, the second rear cover 14 can be connected to the first rear cover 12 stably. In this embodiment, the first engaging portion 124 maybe an engaging recess and the second engaging portion 140 may be an engaging hook. In another embodiment, the first engaging portion 124 may also be an engaging hook and the second engaging portion 140 may also be an engaging recess according to practical applications.

As shown in FIG. 2, after assembling the display device 1, the second fixing portion 122 of the first rear cover 12 is located between the second rear cover 14 and the back plate 102 of the panel module 10. Accordingly, the second rear cover 14 covers the second fixing portion 122 of the first rear cover 12, the screw 16 and the metal plate 20. Therefore, a user will not see the second fixing portion 122 of the first rear cover 12, the screw 16 and the metal plate 20 from the appearance of the display device 1.

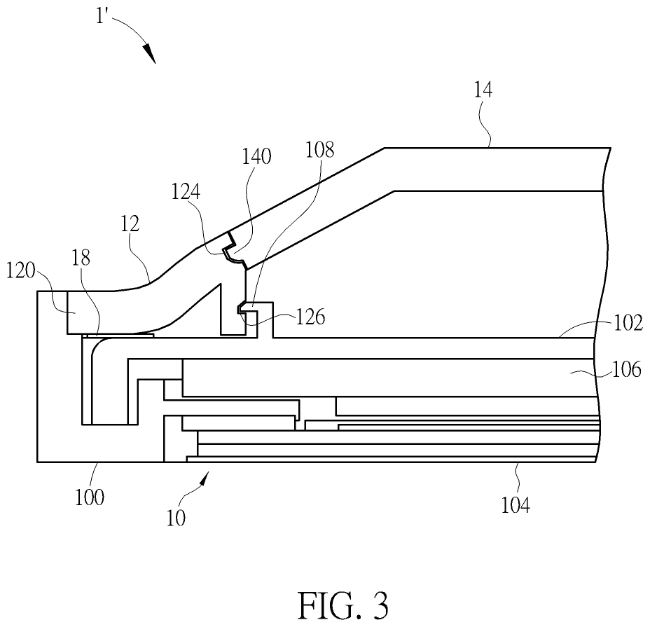

Referring to FIG. 3, FIG. 3 is a partial sectional view illustrating a display device 1′ according to another embodiment of the invention. The main difference between the display device 1′ and the aforesaid display device 1 is that the back plate 102 of the panel module 10 of the display device 1′ comprises a third engaging portion 108 and the first rear cover 12 of the display device 1′ comprises a fourth engaging portion 126. In this embodiment, the third engaging portion 108 may be formed and bended from the back plate 102, but is not so limited. As shown in FIG. 3, the fourth engaging portion 126 engages with the third engaging portion 108, such that the first rear cover 12 is connected to the back plate 102 of the panel module 10. In this embodiment, the invention may dispose a plurality of third engaging portion 108 on the back plate 102 of the panel module 10 and dispose a plurality of fourth engaging portion 126 at an inner edge of the first rear cover 12. Accordingly, the first rear cover 12 can be connected to the back plate 102 of the panel module 10 stably. In this embodiment, the third engaging portion 108 may be an engaging hook and the fourth engaging portion 126 may be an engaging recess. In another embodiment, the third engaging portion 108 may also be an engaging recess and the fourth engaging portion 126 may also be an engaging hook according to practical applications.

Therefore, according to the aforesaid embodiments, the connection manner between the first rear cover 12 and the panel module 10 may comprise at least one of adhesion, screw connection and engagement according to practical applications.

As mentioned in the above, the invention uses the first rear cover and the second rear cover to form a two-piece rear cover. An operator only needs to connect the first rear cover to the panel module first and then connect the second rear cover to the first rear cover, such that the assembly of the display device is completed. Furthermore, the operator only needs to disassemble the second rear cover from the first rear cover, so as to maintain inner components of the display device. Since the first rear cover is connected to the panel module, a front bezel of the panel module can be used as an appearance component, so as to form a narrow and thin frame for the display device.

Those skilled in the art will readily observe that numerous modifications and alterations of the device and method may be made while retaining the teachings of the invention. Accordingly, the above disclosure should be construed as limited only by the metes and bounds of the appended claims.

1. A display device comprising:
a panel module;
a first rear cover connected to the panel module, the first rear cover comprising a first engaging portion; and
a second rear cover comprising a second engaging portion, the second engaging portion engaging with the first engaging portion, such that the second rear cover is connected to the first rear cover;
wherein one of the first engaging portion and the second engaging portion is an engaging recess and another one of the first engaging portion and the second engaging portion is an engaging hook.

2. (canceled)

3. The display device of claim 1, wherein a connection manner between the first rear cover and the panel module comprises at least one of adhesion, screw connection and engagement.

4. The display device of claim 1, further comprising a screw, the panel module comprising a back plate, the first rear cover comprising a first fixing portion and a second fixing portion, wherein the first fixing portion is adhered to the back plate and the screw fixes the second fixing portion to the back plate, such that the first rear cover is connected to the panel module.

5. The display device of claim 4, wherein the second fixing portion is located between the second rear cover and the back plate, and the second rear cover covers the second fixing portion and the screw.

6. The display device of claim 4, further comprising a metal plate, wherein the screw fixes the metal plate to the second fixing portion and the second rear cover covers the metal plate.

7. The display device of claim 1, wherein the panel module comprises a back plate, the back plate comprises a third engaging portion, the first rear cover comprises a fourth engaging portion, the fourth engaging portion engages with the third engaging portion, such that the first rear cover is connected to the panel module.

8. The display device of claim 1, wherein the first rear cover is U-shaped or O-shaped.
